(19) United States
(12) Patent Application Publication
(10) Pub. No.: US 2010/0005001 A1
(43) Pub. Date: Jan. 7, 2010

(54) SYSTEMS AND METHODS FOR ADVERTISING

(76) Inventors: Jonathan AIZEN, San Francisco, CA (US); Eran SHIR, Sunnyvale, CA (US); Jacob UKELSON, Lehavim (IL); Samuel SOMECH, Ramat Gan (IL); Paul David KNEGTEN, New York, NY (US); Itay RABINOWITZ, Jerusalem (IL); Nori JACOBY, Tel-Aviv (IL)

Correspondence Address: Pearl Cohen Zedek Latzer, LLP, 1500 Broadway, 12th Floor, New York, NY, 10036, US

(21) Appl. No.: 12/494,420

(22) Filed: Jun. 30, 2009

Related U.S. Application Data
(60) Provisional application No. 61/076,699, filed on Jun. 30, 2008.

(51) Int. Cl. G06Q 30/00

(52) U.S. Cl. 705/14.73

(57) ABSTRACT

A system for generating an advertisement to be displayed to a website visitor of a webpage, the system including: (a) product selection processing module, configured to select a product to be advertised; (b) an input interface for receiving real time information pertaining to the product; and (c) an advertisement generator, configured to generate the advertisement in response to the real time information and to provide the advertisement for displaying on the webpage.

### CROSS REFERENCE TO RELATED APPLICATIONS

This application claims the benefit of U.S. Ser. No. 61/076,699, filed on 30 Jun. 2008 (and entitled “A SYSTEM, A METHOD AND A COMPUTER PROGRAM PRODUCT FOR GENERATING ADVERTISEMENTS”), which is incorporated in its entirety herein by reference.

### BACKGROUND OF THE INVENTION

Typically, there are two kinds of media used by advertisers/agencies (shortened to ‘agencies’ for the rest of this document)—premium, where the ‘ad space’ is sold in specific ways and at specific price-points by the publisher (e.g. ‘front page of news.yahoo.com’), and remnant—typically everything else a publisher has to offer.

The remnant media is typically unsold inventory—ad spots that the publisher's sales force wasn'table to sell off, and is available to show ads. The publisher understands that it's better to make some money out of this ad space, than nothing at all.

Agencies look to balance their budgets between ‘premium buys’ and ‘remnant buys’—because the latter are typically much cheaper, it's possible they get a good ‘deal’, and give great ROI to the advertiser for the same budget.

In addition, agencies would like to ‘spread around’ their ad impressions across many sites, in case one works better for them then the others—if they wanted to focus on one particular site, they'd negotiate directly with the publishers and buy ‘premium’ inventory, possibly at a discount.

This is where ‘ad networks’ come in—agencies buy media from ad networks because they allow their advertisers to reach a certain demo, within a certain geo, on sites corresponding to a given vertical. This could be done by either the publishers tagging their pages (and corresponding ad slots) appropriately within the system, so the ad network can match the right publishers and advertisers, or by the ad network providing a secret sauce. For example, the publisher just makes their inventory available, and the ad network somehow attributes that impression to a certain demographic. For example, a behavioral ad network might claim to do this by understanding somehow that the person viewing the page belongs to a certain age group, and connecting that impression with an ad that's looking to target that demo.

Now, even with the publishers making remnant media available with tagging (or not), and ad networks adding their secret sauce, it's possible that the ad network does not have enough advertisers to satisfy supply. On the other hand, a different ad network might not have sufficient inventory to satisfy an advertiser that wants to do large campaigns. This is where an exchange like Right Media comes in. They allow networks to link to each other—so it's possible that an advertiser's campaign runs on a publisher from a different network—each network paying a little, and the exchange getting its cut, in the process.

Internet advertising has taken off over the last few years, and advertising spend on the web is taking a good (and growing) share of worldwide advertising spend, especially in the US and Western Europe. The web and its inherent interactivity has brought with it new types of ads (search ads) and new mechanisms for measuring more standard kinds of ads (like banner ads that are similar to print ads). These new measurement mechanisms include impression based measurements (CPM), click based measurements (CPC), and action based measurements (CPA).

Another change has been in the targeting of advertising, where advertisers can target their audiences based on the content of the page being viewed (contextual advertising). This allows for more ad relevancy than just segmenting an advertisers products and matching it with the segmentation of the type of readers\users at a specific site. A new type of targeting is also starting to gain a foothold—behavioral targeting where rather than try and match the content of the current page with an advertisement, behavioral advertising takes into account other aspects of the user (e.g. browsing history, location, time-of-day) and attempts to serve ads that take into account all those factors when selecting an appropriate ad to serve to a particular user, on a particular site at a particular time.

These advancements in ad targeting also brought with them advancement is the type of ads that can be placed. Rich media ads (including video) and dynamic ads that take into account the keyword that was matched to cause a specific, relevant advertisement to selected. All of these techniques are attempting to generate greater ad relevancy, thereby increasing the chance that the ad will be noticed and generate a response from the user. Today's dynamic ads struggle with relevancy since they change, at best, to take into account the advertiser's catalogue of products, the keyword matched for the contextual placement of the ad. Even though they are also an important part of converting a “browser” to a “customer”, not much technology has bled over into the creation of dynamic landing pages associated with the ads (further information is available from http://en.wikipedia.org/wiki/Landing_page) though there has been quite a bit of knowledge and folklore gained in how to build effective landing pages.

Mash-up based advertisements (that are joint with mash-up related landing pages) that take into account the advertiser's web site (and their current catalogue), the content of the publisher's page being viewed, user information, and possibly relevant 3rd party information (e.g. from general or specific informational sites related to the current context) will enable much more relevant ads. These mash-up ads will take the feeds from various sources and be similar to mash up applications (further information is available from http://en.wikipedia.org/wiki/Mashup_(web_application_hybrid) that are specifically tailored to the needs of advertising—allowing advertising agencies to quickly pull together diverse data sources (or feeds) into a design template in order to create a dynamic mash-up ad and its corresponding landing page. By associating the feeds used with semantic information and limiting it to the advertising domain, these mash-ups can be created more easily than by using standard, non-semantic mash-up makers. Such mash-up ads will allow for advertisements that never been seen before on the web, and allow not only for the targeting of ad placement based on the publisher's content but also allow for tailoring the content of the advertisement to be targeted to the content of the publishing site.

### SUMMARY OF THE INVENTION

A system for generating an advertisement to be displayed to a website visitor of a webpage, the system including: (a) product selection processing module, configured to select a product to be advertised; (b) an input interface for receiving real time information pertaining to the product; and (c) an advertisement generator, configured to generate the advertisement in response to the real time information and to provide the advertisement for displaying on the webpage.

A system for generating an advertisement to be displayed to a website visitor of a webpage, the system including: (a) a campaign parameters manager, configured to update a value of a campaign parameter of a campaign of an advertiser, in response to information received from the advertiser; (b) a product selection processing module, configured to select a product in response to intent indicative information that is indicative of an intent of the website visitor, and to the value of the campaign parameter; and (c) an output interface for providing an advertisement of the product for displaying on the webpage.

A method for generating an advertisement to be displayed to a website visitor of a webpage, the method including: (a) selecting a product to be advertised; (b) retrieving real time information pertaining to the product; (c) generating the advertisement in response to the real time information; and (d) providing the advertisement for displaying on the webpage.

A method for generating an advertisement to be displayed to a website visitor of a webpage, the method including: (a) receiving intent indicative information, indicative of an intent of the website visitor; (b) updating a value of a campaign parameter of a campaign of an advertiser, in response to information received from the advertiser; (c) selecting a product in response to the intent indicative information, wherein the selecting is responsive to the value of the campaign parameter; and (d) providing an advertisement of the product for displaying on the webpage.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B illustrate methods for generating an advertisement to be displayed to a website visitor of a webpage, according to various embodiment of the invention;

FIG. 2 illustrates a system for generating an advertisement to be displayed to a website visitor of a webpage, according to an embodiment of the invention;

FIG. 3A illustrates an architecture of a system for generating an advertisement to be displayed to a website visitor of a webpage, according to an embodiment of the invention;

FIG. 3B illustrates a searching and/or matching module, according to an embodiment of the invention;

FIG. 4 illustrates a method for generating advertisement, according to an embodiment of the invention;

FIG. 5 illustrates a method for generating advertisement, according to an embodiment of the invention; and

FIG. 6 illustrates an advertisement generated in response to intent indicative information, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

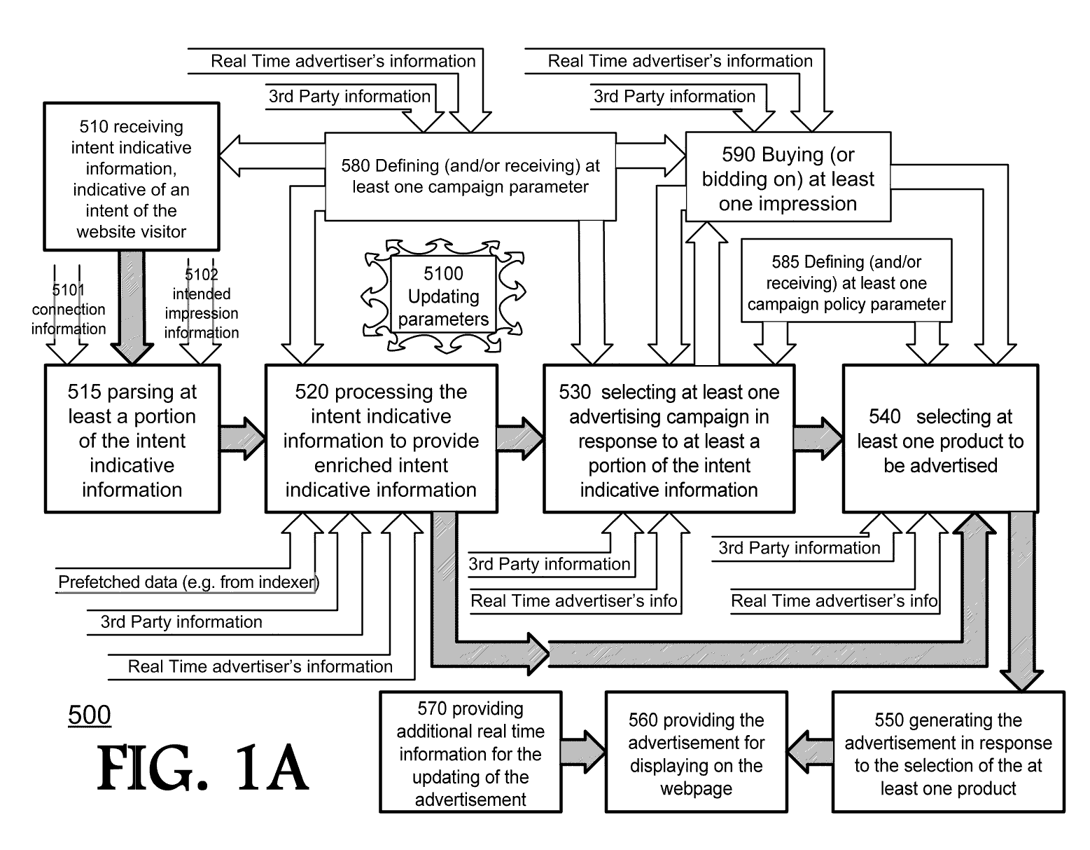

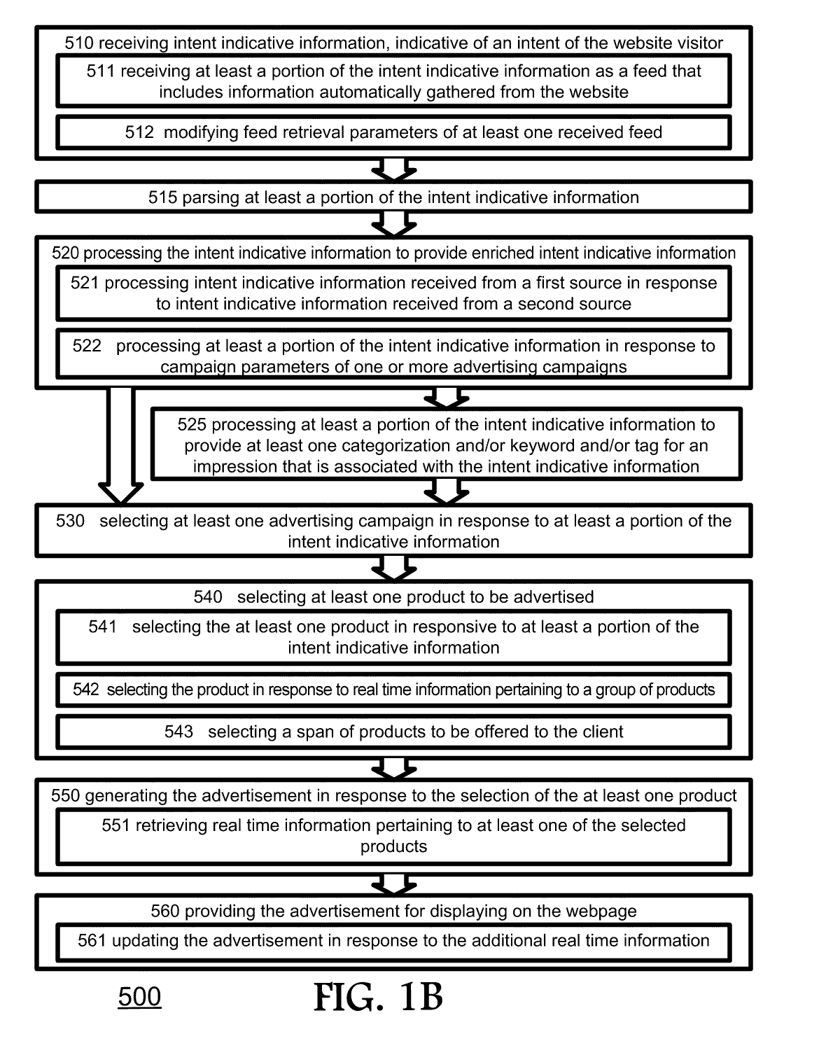

FIGS. 1A and 1B illustrate method 500 for generating an advertisement to be displayed to a website visitor of a webpage, according to various embodiment of the invention. It is noted that method 500 may implement, according to an embodiment of the invention, when is also referred to as “Dynamic Advertising”.

It is noted that various embodiments of method 500 may be implemented by different embodiments of system 200 and/or of system 300, mutatis mutandis, even if not explicitly elaborated.

According to an embodiment of the invention, dynamic ads allow a single creative to be used for an unlimited number of banner ads, allowing the ad to morph itself based on targeting information (which may be derived from intent indicative information and possibly from other types as information as well, as explained below), personalizing itself to the website visitor user and her intent. The targeting information can be of many types (e.g. contextual, behavioral, meta-data, geo) and obtained from many sources (e.g. retargeting pixel, textual page analysis).

According to an embodiment of the invention, the advertisement may be built by combining the real-time data and the creative to create a specific ad instance to present to the website visitor. The advertisement may than conveniently be served to the website visitor through standard ad serving mechanisms, and the ad can be linked back to any page on the advertiser's website (e.g. a link to a specific item, a specific offer, or a standard landing page).

Method 500 conveniently starts with stage 510 of receiving intent indicative information, indicative of an intent of the website visitor. It is noted that the intent indicative information may be responsive to content explicitly expressed by the website visitor (e.g. a search query, navigating within a categorically structured website, etc.), may be responsive to analysis of user action and/or behavior which is not explicitly expressed by the user (e.g. analysis of web surfing habits to estimate age group), and may also be independent of the user actions (e.g. the topic of the web page visited, etc.). Referring to the examples set forth in the following drawings, the receiving of the intent indicative information may be carried out by an intent indicative information input interface such as intent indicative information input interface 210 of system 200.

It is noted that the intent indicative information may conveniently be received in relation to a specific intended impression—e.g. when the website visitor requests to load the webpage, and the webpage is intended to include one or more advertisements, each of the intended advertisement may be regarded as an intended impression (wherein it is noted that the intent indicative information may be the same for all of the indented impressions of the webpage).

The intent indicative information may include, for example, the URL of the webpage (which may be indicative of user entered information—e.g. search terms), geographic location of the user, technical information regarding to the system used by the website visitor to access the web-page, demographic information of the user, behavioral information of the user, and so forth.

The receiving of the intent indicative information may include receiving information indicative of browsing information of the user (e.g. by different kinds of cookies), such as browsing history, previous visits to the website (or to other websites, which may be considered similar and may be different), and so forth.

The receiving of the intent indicative information may include receiving of intent indicative information which is provided by the website (with or without request) or by an entity associated with which (e.g. the publisher), by an advertising agency or advertising network that is associated with the website, by the website visitor, and so forth.

According to an embodiment of the invention, the receiving of the intent indicative information includes stage 511 of receiving at least a portion of the intent indicative information as a feed that includes information automatically gathered from the website. Such a feed may be provided by the website or by an entity associated with which, and may also be provided by an automatic cropping, indexing, and/or monitoring system, that transmits information (usually specific fields) from the website and/or webpage. Referring to the examples set forth in the following drawings, the receiving of such a feed may be carried out by an input interface such as input interface 260 of system 200.

It is noted that such a received feed may be promoted by the website (e.g. a predefined web feed that is promoted when browsing to the browsed web site or browsed web page), and may be defined by different entities. According to an embodiment of the invention, the received feed is defined by the website owner (also referred to as publisher or content distributor)—for example in order to facilitate more effective advertising in the website (usually for increasing the revenues from advertising). According to an embodiment of the invention, the feed may be defined in response to campaign parameters or to other parameters, by a system that carries out method 500, by an operator of such system, or to otherwise accommodate for the need of such a system.

According to an embodiment of the invention, method 500 may further include stage 512 of modifying feed retrieval parameters of at least one received feed (either in response to campaign parameters or not). That is, a system which carries out method 500 may request a feed provider (e.g. a website owner, a publisher, an ad network, or any other entity, such as the ones discussed above) to receive a different and/or modified feed, usually in order to receive intent indicative information which is better suited to the current needs of advertising management.

One of the ways of receiving the intent indicative information from the publisher includes receiving the intent indicative information from at least one semantic template (or semantic feed) that is created by the publisher. The publisher may create a semantic template (also referred to as “Dapp”, in products by Dapper, Inc.) for each page that would benefit from dynamic ads. The publisher may than insert that feed URL instead of the standard ad URL, and when the page is served, a linked semantic template is executed—the website (or webpage) itself is parsed to find the relevant fields and possibly keywords.

It is noted that a similar technique may be used for receiving from the publisher information relevant for other stages, e.g. for the defining of keywords or other campaign parameters, e.g. as discussed in relation to stage 580. According to such an embodiment of the invention, stage 580 may include matching the parsed fields and/or keywords to the fields defined by advertiser's feeds, wherein an appropriate advertiser feed may be selected to serve up the appropriate feed as an image used for the advertising.

According to an embodiment of the invention, stage 512 may include modifying the feed retrieval parameters in response to a change of at least one campaign parameters. For example, if a new campaign for winter sports equipment was added, the feed retrieval parameters may request for information indicative of winter sports related intents.

It is noted that the term “feed” as used herein may refer to preconfigured feeds such as, by way of example, RSS feeds, and dynamic feeds that require input before providing the feed (e.g. by way of APIs). A web feed may be associated with a website (or with multiple websites) if it is associated with any one of the web pages of that website.

It is noted that some of the intent indicative information received in stage 510 may be provided as a Dapp feed (which is a feed supported by different products of Dapper Inc.), e.g. a feed as disclosed in U.S. patent application Ser. Nos. 11/868,987, 11/868,981, and 11/940,387, which are enclosed herein in their entirety.

It is noted that method 500 may include receiving a portion of the intent indicative information previously, in order to accelerate the processing of the information. For example, known websites and/or URLs may be analyzed routinely (regardless of a specific intended impression), e.g. to be later associated with different intents (e.g. travel, hotels, education, etc.) the portion of the intent indicative information that is received prior to the receiving of stage 510 (which is the one which may be associated with the intended impression, and which may be triggered by a requesting of the specific webpage to be viewed to the specific website visitor) may be processed prior to the processing of stage 520. The receiving of the previously fetched intent indicative information may include retrieving of either processed or preprocessed intent indicative information.

Also, it is noted that some of the intent indicative information received in stage 510 may be statistical in nature (e.g. statistical demographic information of the website), or otherwise estimated information.

According to an embodiment of the invention, method 500 may further includes receiving of additional information—which is not directly related to an intent of the user. For example, the connection speed of the user may be determined (denoted 5101, e.g. to select between a video advertisement to a textual advertisement), information relating to the intended impression (denoted 5102, e.g. location within the webpage, etc.), and so forth.

According to an embodiment of the invention, method 500 may include stage 515 of parsing at least a portion of the intent indicative information. It is noted that some of the intent indicative information may require a preprocessing parsing process—e.g. to extract certain desired parameters and/or values from a bulk of information that is received in stage 510. It is noted that the intent indicative information that is processed and/or used later in the process (e.g. in stages 520, 530 etc.) may include only some of the intent indicative information received in stage 510, and may also include intent indicative information that is received by parsing and/or preprocessing information included in the intent indicative information received in stage 510. It is further noted that wherever the term “intent indicative information” is used, embodiments of the invention which utilize additional information (e.g. as disclosed in relation to 5101, 5102) may further be included, processed, or utilized. Referring to the examples set forth in the following drawings, the parsing may be carried out by an intent indicative information parser such as intent indicative information parser 215 of system 200.

Stage 520, which may and may not be carried out, includes processing the intent indicative information to provide enriched intent indicative information. The enriched intent indicative information may be used for improving advertising success (e.g. by improving parameters such as click rate, by better matching the advertisements presented to the different website visitors), for example by selecting a matching advertising campaign out of several campaigns. Referring to the examples set forth in the following drawings, the processing of the intent indicative information to provide enriched intent indicative information may be carried out by an intent processing module such as intent processing module 220 of system 200, or intent processing module 320 of system 300.

It is noted that the processing of stage 520 may include processing the intent indicative information to provide enriched intent information which is useful for selecting between multiple advertising campaigns (and as such may be responsive to campaign parameters of several campaigns).

It is noted that the processing (which may also be referred to as “enriching”) of stage 520 may include combine intent indicative information from different sources—for example, information that is received from cookies stored at the user computer may arrive separately and in different channels than information pertaining to the website.

Stage 520 may include, according to an embodiment of the invention, stage 521 of processing intent indicative information received from a first source (e.g. from the website, etc.) in response to intent indicative information received from a second source (e.g. from such a cookie, from a preprocessed index, etc.).

The processing of the intent indicative information may include processing the intent indicative information in response to weighing parameters (“weights”). For example, the processing of the intent indicative information may include assigning different weights to different data of the intent indicative information, for enabling more effective a selection of an advertising campaign later on. The weighing parameters may also be used for other uses—e.g. ignoring some of the intent indicative information, or providing aggregated intent indicative information in view of the weights assigned to the data of the received intent indicative information.

According to an embodiment of the invention, the processing of stage 520 may further include processing of information received from a third party (or from other resources such as local databases). For example, the processing of the intent indicative information may be responsive to local weather at the location of the website visitor, to local holidays at that location, to the time of the day, to sociological trends, to news events, economical events, and so forth. Such additional third party information may be added to the intent indicative information, and/or may be used to process other data of the intent indicative information (e.g. by using for calibrating weighing parameters).

According to an embodiment of the invention, the processing of the intent indicative information may include weighing intent indicative information in response to reliability of the sources from which the data was received/retrieved.

According to an embodiment of the invention, the processing of stage 520 includes stage 522 of processing at least a portion of the intent indicative information in response to campaign parameters of one or more advertising campaigns. The campaign parameters may be, for example, weighing parameters, keywords, tags, and so forth.

For example, when a new advertising campaign is entered into a system that carries out method 500, campaign related keywords may be defined (and/or detected), wherein the processing of the intent indicative information may further search for those keywords. The campaign parameters may be defined, according to an embodiment of the invention, in stage 580.

It is noted that the parsing of stage 515 may be responsive, according to various embodiments of the invention, to the various factors that are discussed in relation to the processing of stage 520.

Method 500 may include stage 580 of defining at least one campaign parameter, of one or more campaigns. It is noted that in different embodiments of the invention, different types of campaign parameters may be implemented, e.g. weights, tags, keywords, and so forth. It is noted that campaign parameters may also be received from an external source (e.g. advertiser), instead of being defined. Referring to the examples set forth in the following drawings, the defining of the at least one campaign parameters may be carried out by a campaign parameters manager such as campaign parameters manager 240 of system 200.

It is noted that the campaign parameters may be used at different stages of method 500. For example, the receiving of the intent indicative information may depend (at least partly) on campaign parameters—e.g. by defining parameters used for the creating of the automatic feed from the website. The processing of the intent indicative information to provide the enriched intent indicative information may also depend on the campaign parameters, e.g. as discussed above, and so does further stages of method 500 may and may not depend on the campaign parameters (e.g. stages 530, 540, and so on). It is noted that different stages of method 500 may depend on at least partly different campaign parameters. According to an embodiment of the invention, the campaign parameters may also relate to which campaigns are relevant for a specific selection. For example, some of the campaigns may not be relevant to adult content websites, other campaigns may wish to remove themselves from pop-culture websites or from banking websites, while yet other campaigns may not wish to relate to website visitors of certain demographics (e.g. older than 35) at all. Such hard-line policies may be implemented, for example, to prevent advertising which are not suitable for the advertiser branding, or to avoid unnecessary computations.

The defining of the campaign parameters may include, according to an embodiment of the invention, processing information received from the advertiser (e.g. from an advertiser website, from an advertiser dedicated webpage, or from an advertiser promoted feed) for defining the campaign parameters. For example, the advertiser may provide a promoted feed that includes information pertaining to all the products that are offered for sale in a given campaign, which can be processed for determining keywords, weights, etc.

Additionally, the defining of the campaign parameters may include, according to an embodiment of the invention, processing information received from other source (e.g. third party, local databases, etc.), for example similarly to the discussed above techniques.

It is noted that different parameters may be defines (and/or received) for different advertising campaigns. Likewise, similar parameters, which are not necessarily related to a specific campaign, may also be defined and utilized in the different stages of method 500. Such parameters may be responsive for example to third party information, may relate to system parameters and/or optimization parameters, and so forth. By way of example, one group of such parameters may relate to connections between different keywords to demographic parameters of websites visitors (e.g. age thereof).

According to an embodiment of the invention, each of the at least one advertisers may create a separate feed for each of their main dynamic merchandise categories (semantic categories), which may be received and used in stage 580 for defining the campaign parameters. If we take a clothing retailer as an example—it could be men's clothing, women's clothing, children's shoes etc. It is noted that method 500 may be especially effective for dynamic merchandise such as sales or specials. Other types of dynamic merchandise include jobs, classifieds, news etc.

As aforementioned, according to an embodiment of the invention the campaign parameters include dynamic keywords which may be used for the preferring and/or categorizing of different intents. Different techniques may be implemented in method 500 for the extraction of such keywords, few of which are detailed below.

According to an embodiment of the invention, stage 580 includes a first way of extracting keywords, that includes retrieving a simple feed or a webpage (conveniently there is a feed or a webpage dedicated for each advertising category—such as travel, jobs). The retrieving of the feed or webpage may include fetching the complete feed or webpage on a schedule, wherein stage 580 may further include analyzing the feed or webpage (e.g. based on data types, and generating the appropriate keywords.

For example, method 500 may include retrieving from the advertiser and/or from the campaign definition a list of possible structures in the intent, such as a list of keywords, and/or a “structure” of more general type, such as a currency quote. In another example, a list of keywords related to a certain semantic category (although this category may not be given or calculated explicitly) may also serve as a data type, for example if in stage 580 a list of cars is retrieved, and a word like “Golf” is found, the method may include identifying that word is related to the “data type” cars, and in stage 510 this word may be tagged as possible “car”.

According to an embodiment of the invention, stage 580 includes a second way of extracting keywords, that includes retrieving a collection (“dump”) of all possible search keywords (e.g. from an advertiser website, for a database, and/or from a domain knowledge), wherein stage 580 may further include using the collection for fetching the complete feed for each category, analyzing the feed (e.g. based on data types), and generating the appropriate keywords. For example, relating to the data types as discussed above, once those data types are defined, they can be pre-searched, e.g. like a normal extension of normal keyword scan.

According to an embodiment of the invention, stage 580 includes a third way of extracting keywords, that includes receiving (e.g. from the advertiser) a list of interesting keywords for a site. It is noted that the receiving of such a list may pose a problem, since some keywords are interesting and expensive—but there may be no relevant dynamic data (e.g. product to advertise) matching for that keyword. Therefore, according to an embodiment of the invention, stage 580 may further includes checking for each of the keywords in the list that there is a relevant ad (e.g. a campaign, a product).

Method 500 may further include stage 530 of selecting at least one advertising campaign in response to at least a portion of the intent indicative information. It is noted that according to an embodiment of the invention (which is not illustrated), the selecting may be responsive to intent indicative information that is not processed (e.g. if stage 520 is not implemented, or when it is implemented as part of stage 530). According to an embodiment of the invention, the selecting of the at least one advertising campaign may be responsive to at least a portion of the enriched intent indicative information. It is noted that according to an embodiment of the invention, all of the one or more products to be advertised may not be divided into different groups of campaign, in which case the selection of advertising campaign may not be required. Referring to the examples set forth in the following drawings, the selecting of the at least one advertising campaign may be carried out by a campaign selection processing module such as campaign selection processing module 225 of system 200.

For example, the selecting of the at least one advertising campaign may include processing the intent indicative information in order to select a category (or several categories) of intentions to which the intent indicative information may be categorized (e.g. travel, education, cars, jobs, etc.), and selecting one or more advertising campaigns which correspond to the selected category. It is noted that such categories are not necessarily implemented, and that the description of such simplified categories, while implementable in various embodiments of the invention, is offered for clarifying the invention.

It is noted that according to an embodiment of the invention, only a single campaign is selected. According to an embodiment of the invention, several advertising campaigns may be selected and ranked, so that if one selected campaign is abandoned when the process continues, the process may continue with another campaign. As will become clear from the further discussion, it is noted that the selecting of stage 530 and that of stage 540 (yet to be disclosed) are not necessarily entirely separable, and that selection consideration implemented in stage 540 may require reconsideration of the selecting of stage 530, and vice versa.

It is noted that each advertising campaign may be associated with a different advertiser, but this is not necessarily so. A single advertiser may have distinct campaigns (even though it is noted that a single campaign may include products very distinct from one another, e.g. shoes and off-the-shelf medications), and a single advertising campaign may include, according to an embodiment of the invention, products and/or advertisements of several advertisers (e.g. of independent contractors working in the same field).

It is further noted that in an embodiment of the invention, one or more of the at least one advertising campaign may be replaced with other group of one or more products and/or advertisements.

It is noted that, the selecting of the at least one advertising campaign may conveniently be further responsive to campaign parameters of one or more advertising campaigns (which may be received or determined in any of the ways discussed above in relation to stage 580).

According to an embodiment of the invention, the selecting of the at least one advertising campaign may be responsive to campaign policy of one or more advertising campaigns. It is noted that the campaign policy may be part of the campaign parameters, but it is described in a distinct manner, because it may also be implemented independently. The campaign policy (which may be received and/or determined in stage 585) conveniently includes parameters which relates to selection of products to be advertised within the campaign.

According to an embodiment of the invention, the selecting of stage 530 may be responsive to commercial parameters (e.g. cost of intended impressions, secured amount of impressions for each campaign, etc.). For example, at least a portion of the commercial parameters may be received from a media manager (also referred to as media buy manager) that handles the purchasing of (and/or bidding on) the intended impression, e.g. in stage 590.

Stage 590, which may and may not be a part of method 500, includes buying (or bidding on) at least one impression (in which the intended impression may conveniently be included). It is noted that the buying of the one or more impressions may depend, according to an embodiment of the invention, on the campaign parameters of one or more of the advertising campaigns. Referring to the examples set forth in the following drawings, stage 590 may be carried out by a media manager such as media manager 250 of system 200.

It is noted that the buying (or bidding on) of an impression may influence the selection of advertising campaign (in stage 530) and/or of a product (in stage 540), but may also be affected by which. For example, if the one or more campaigns which are selected in stage 530 as ones which may be interested in advertising to such a website visitors can not afford the intended impression, the media manager may choose not to purchase that intended impression (or to sell it, if possible).

It is noted that the buying and/or bidding of one or more impressions in stage 590—or the refraining from which—may also depend on third party information.

According to an embodiment of the invention, stage 590 includes buying (or bidding on) ads or impressions based on keywords, e.g. by submitting keywords to various ad networks (such as Google, YPN, DoubleClick, aQuantative, and so forth). According to an embodiment of the invention, stage 590 includes implementing at least one budget based optimization technique to purchase keywords.

It is noted that according to an embodiment of the invention, method 500 does not continue toward generating an advertisement, but rather towards selling categorized impressions, in which case stage 530 may be replaced by stage 525 of processing at least a portion of the intent indicative information (may be enriched intent indicative information), to provide a categorization (and/or at least one keyword and/or at least one tag) for an impression that is associated with the intent indicative information, and/or to the webpage, and/or to the website, and so forth. It is noted that such processing may be carried out in parallel to stage 530 (or as a part of it), wherein the categorization/keyword/tag may be sold only if no matching product was selected in method 500.

Method 500 may conveniently further include stage 540 of selecting at least one product to be advertised, wherein the selecting of stage 540 may conveniently include selecting of a product which belongs to the selected advertising campaign. For example, if the advertising campaign of a sporting goods vendor was selected in stage 530, stage 540 may include selecting of one or given models of tennis shoes. It is noted that the selection of more than one product may usually be implemented if several intended impressions are available for the website visitor (e.g. if method 500 is carried out by a large advertising agency that have monopoly of the publisher's impressions), or for advertisements that advertise more than a single product (e.g. side by side, or in a selectable manner). Referring to the examples set forth in the following drawings, the selecting of the at least one product to be advertised may be carried out by a product selection processing module such as product selection processing module 230 of system 200, or product selection processing module 330 of system 300.

The selecting of the product may conveniently include stage 541 of selecting the at least one product in responsive to at least a portion of the intent indicative information (and/or of the enriched intent indicative information).

According to an embodiment of the invention, the selecting of stage 540 may include stage 542 of selecting the product in response to real time information pertaining to a group of products. Such real time information may be cropped from a website of the (at least one) advertiser (either a commercial website or dedicated web-pages), may be provided by a feed by the advertiser (which may be received, referring to the examples set forth in the following drawings, by an input interface such as input interface 260 of system 200), and so forth.

According to an embodiment of the invention, each of the at least one advertisers may create a separate feed for each of their main dynamic merchandise categories (semantic categories), which may be received and used in stage 540 for selecting the at least one product. If we take a clothing retailer as an example—it could be men's clothing, women's clothing, children's shoes etc. It is noted that method 500 may be especially effective for dynamic merchandise such as sales or specials. Other types of dynamic merchandise include jobs, classifieds, news etc.

It is noted that method 500 (and stage 540 especially) may be implemented in relation to different kinds of products—material and/or immaterial (e.g. services), but may also be implemented for other types of objects—e.g. promotion material, or other types of information. Also, the product may not only be advertised (in later states of method 500), but it may also be actually provided. E.g., if the product is an anti-virus scan, the advertisement may actually start when selected by the website visitor.

According to an embodiment of the invention, stage 540 may be implemented as stage 543 of selecting a span of products to be offered to the client. It is noted that the advertisement which will eventually be provided to the website visitor may include an interface that may enable the website visitor to search among the span of selected products.

Method 500 further include stage 550 of generating the advertisement in response to the selection of the at least one product. The generating of the advertisement may conveniently include stage 551 of retrieving real time information pertaining to at least one of the selected products, wherein the generating of the advertisement includes generating the advertisement in response to the real time information. The retrieving may conveniently be carried out over an internet connection. Referring to the examples set forth in the following drawings, the generating of the advertisement may be carried out by an advertisement generator such as advertisement generator 270 of system 200.

It is noted that the generating of the advertisement may be responsive to additional information (e.g. third party information, indexed information, and so forth), e.g. as discussed above in relation to previous stages of method 500.

It is noted that, according to an embodiment of the invention, the retrieving includes retrieving the information from a promoted feed that is received from an external system over an internet connection, or from a structured feed/template. It is noted that the retrieving of the real time information may include retrieving information on non-selected products as well.

According to an embodiment of the invention, the retrieving of the real time information from the feed may include receiving the promoted feed that includes: (a) at least one selected element out of multiple elements of a web content representation (e.g. an element that indicates a title of a first item for sale, in an advertising website); and (b) at least one equivalent element that is similar to the selected elements, and which is selected by the external system in response to a selection of the at least one selected element (e.g. titles of other items offered for sale in that websites, which were selected by the external system after analyzing the selection of the title of the first item as a selection of the title field).

The generated advertisement may include a link to a webpage of the advertiser, but this is not necessarily so. The generated advertisement may, according to an embodiment of the invention, include an interactive interface for enabling the website visitor to request additional data to be provided.

The creative of the advertisement may be selected and/or defined during stage 550 or prior to it. The creative selected may depend on the product selected, but this is not necessarily so. For example, a similar creative may be used for all the products of a given advertiser, wherein only the product description and the price may be modified. The selection of the creative may depend on other information but the product selected—e.g. the intent indicative information, third party information, connection speed, etc.

It is noted that according to an embodiment of the invention, the advertisement may be generated using an image received from a dynamic feed. It is noted that such as implementation may be useful—by way of example—when the advertiser already has direct relationships (e.g. through an agency, or directly with publisher), while method 500 may enable a percentage of the ads to be more dynamic and relevant, thus increasing the click through rates.

According to such an embodiment of the invention, the advertiser may create a separate feed for each of its main dynamic merchandise categories (semantic categories), and create a dynamic GIF (or other type of image) for each of these feeds and default image for of these feeds. In such a case stage 540 may include determining if intent indicative information that is provided by the publisher (or an intermediary entity such as an ad agency) includes an appropriate keyword (or parallel information), wherein if the answer is positive, the appropriate feed image (of the advertiser) is displayed, and otherwise a default image ad is shown. For example, according to one embodiment, the publisher may provide an appropriate keyword to feed, which returns an image—if there is an appropriate feed image ad it is shown, otherwise the default image ad is shown, or—if an ad agency is using the technology—they can allow for a set of feeds to be searched to find one that has a relevant feed, or fall back to a default. It is further noted that if the publisher generates a dynamic template for the publisher's website (e.g. a Dapp), that describes the important information on the site and, this dynamic template may be used to find the most appropriate dynamic ad feed

Method 500 may also include stage 560 of providing the advertisement for displaying on the webpage. The providing may include the actual displaying, the transmitting of the advertisement to a system of the user, or to an intermediary system. According to an embodiment of the invention, the advertisement may be provided together with the rest of the webpage, but this is not necessarily so. Referring to the examples set forth in the following drawings, the providing may be carried out by an advertisement output interface such as advertisement output interface 280 of system 200.

According to an embodiment of the invention, method 500 may further include stage 570 of providing additional real time information for the updating of the advertisement (wherein stage 560 may include stage 561 of updating the advertisement in response to the additional real time information). Such additional information may relate to information requested by the user (e.g. if user browsed, or queried), may pertain to additional products (e.g. the initial advertisement may include information pertaining to only one product, for fast loading, while additional information may be sent later, e.g. after a period of time, or when the user seems to be active).

It is noted that method 500 may further include stage 5100 of updating parameters used for the processing and/or selecting in any one of more of the other stages of method 500, e.g. in response to success parameters (e.g. click rates, total revenue, etc.) The updating of the parameters (which is usually intended for optimizing thereof) is discussed below. It is noted that since in some embodiments the advertisement includes interface which does not require actual clicking of the advertisement for being transmitted to the advertiser's website (e.g. by leafing through the different products), such activities may also be recorded and used for the updating of stage 5100. Referring to the examples set forth in the following drawings, the updating may be carried out by a campaign parameters manager such as campaign parameters manager 240 of system 200. According to an embodiment of the invention, method 500 further includes printing the advertisement generated (either as part of the webpage, or not).

It is noted that, according to an embodiment of the invention, method 500 may be implemented for using existing ad-networks and context based advertising. According to some of its implementations, method 500 requires no changes in usage or process from the publishers (albeit as aforementioned, publisher can improve performance, e.g. by creating a dedicated feed for intent indicative information, etc.) Advertisers should usually see better click-through rates (or improvement in other desired metrics), which should cause them to pay more for this type of ads.

According to an embodiment of the invention, method 500 further includes providing to the advertiser information pertaining to the publishing of one or more advertisement. This may be implemented, for example, by creating a set of feeds (or gadgets) that allow the advertiser to monitor the different ad networks

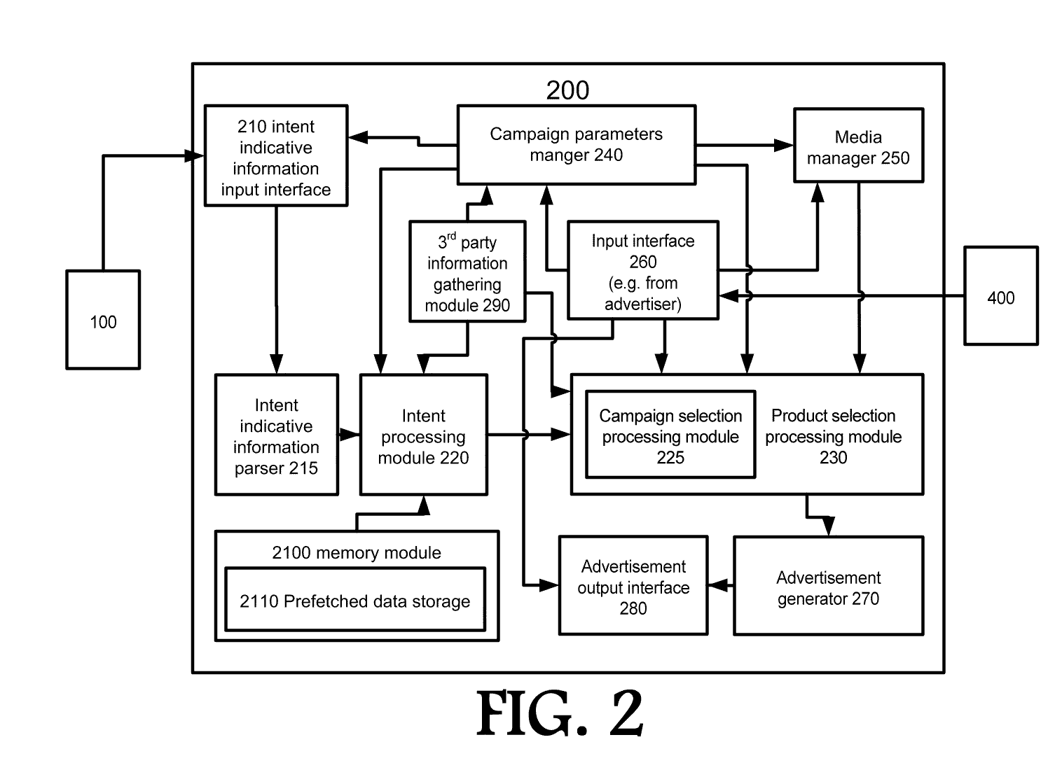

FIG. 2 illustrates system 200 for generating an advertisement to be displayed to a website visitor of a webpage, according to an embodiment of the invention. It is noted that according to an embodiment of the invention, system 200 may implement one or more stages of method 500, even if not explicitly stated so.

System 200 includes, according to an embodiment of the invention, at least product selection processing module 230 that is configured to select a product to be advertised; input interface 260 for receiving real time information pertaining to the product; and advertisement generator 270 which is configured to generate the advertisement in response to the real time information and to provide the advertisement for displaying on the webpage.

According to an embodiment of the invention, advertisement generator 270 is configured to generate the advertisement that includes at least some of the real time information.

According to an embodiment of the invention, input interface 260 is for receiving a promoted feed that includes at least a portion of the real time information (and possibly also non-real time information), and that is received from an external system (e.g. advertiser's website stored on advertiser's computer 400) over an internet connection.

According to an embodiment of the invention, input interface 260 is for receiving a the promoted feed that includes: (a) at least one selected element out of multiple elements of a web content representation; and (b) at least one equivalent element that is similar to the selected elements, and which is selected by the external system in response to a selection of the at least one selected element.

According to an embodiment of the invention, system 200 is further configured to update the advertisement (either by advertisement generator 270 or by another component of system 200)—after the providing of the advertisement—in response to additional real time information that is different from the real time information. This may be used, for example, to update data provided in the information (e.g. number of seats left in a flight), for providing information of additional products (e.g. additional hotels in a city that is mentioned in the intent indicative information), and so forth.

According to an embodiment of the invention, system 200 for generating an advertisement to be displayed to a website visitor of a webpage includes at least: (a) campaign parameters manager 240 which is configured to update a value of a campaign parameter of a campaign of an advertiser, in response to information received from the advertiser (e.g. via input interface 260); (b) product selection processing module 230 which is configured to select a product in response to intent indicative information that is indicative of an intent of the website visitor, and to the value of the campaign parameter; and (b) output interface 280 for providing the advertisement of the product for displaying on the webpage (e.g. in a browser of system 100).

As for product selection processing module 230, it is noted that according to such an embodiment of the invention, the processing of the intent indicative information in view of the updated value of the campaign parameters indicate that in different times, different products may be selected for similar intents. This may depend, for example, on the products available for sale and their respective prices, and/or on other data which is received from the advertiser (usually automatically), as well as on campaign policy parameters received from the advertiser.

It is noted that product selection processing module 230 (as well as other components of system 200, such as for example, intent processing module 220, campaign parameters manager 240, media buyer 250, advertiser generator 270, and so forth) may also process information and/or make proper selection based on third party information (which may be gathered by one or more third party information gathering module 290). For example, the selection of the product to be advertised may be responsive to weather information pertaining to the location of the website visitor.

According to an embodiment of the invention, system 200 includes intent processing module 220 that is configured to process the intent indicative information in response to the campaign parameter (whose value may be updated by campaign parameters manager 240), to provide enriched intent indicative information that is different from the intent indicative information; wherein product selection processing module 230 is configured to select the product in response to the enriched intent indicative information.

According to an embodiment of the invention, system 200 includes input interface 260 for receiving from the advertiser the information as a promoted feed that is received from an external system (e.g. system 400) over an internet connection.

According to an embodiment of the invention, advertiser generator 270 is configured to generate the advertisement in response to real time information pertaining to the product.

According to an embodiment of the invention, system 200 may include campaign selection processing module 225 (which may and may not be a part of product selection processing module 230), which is configured to select an advertising campaign in response to the intent indicative information, before the selecting of the product; wherein product selection processing module 230 is configured to select the product which is a product of the advertising campaign.

According to an embodiment of the invention, system 200 may include intent indicative information parser 215, that is configured for parsing at least a portion of a raw intent indicative information that is received from a computer 100 of the website visitor or from other sources (e.g. via intent indicative information input interface 210).

According to an embodiment of the invention, system 200 includes one or more memory modules 2100, for storing information required for the generation of the advertisement. For example, memory module 2100 may include prefetched data storage 2110, that is used for storing intent indicative information data that is received not in real time (e.g. information pertaining to websites visited by the website visitor), for the speeding of the processing. It is noted that the prefetched data stored in 2110 may be processed or not (and/or enriched or not).

According to an embodiment of the invention, memory module 2100 may include a computer readable medium, having a computer readable code embodied therein, wherein the computer readable code may include instructions for the carrying out of one or more stages of method 500 by one or more components of system 200. It is noted that different such memory modules computer readable mediums may be incorporated into different components of system 200.

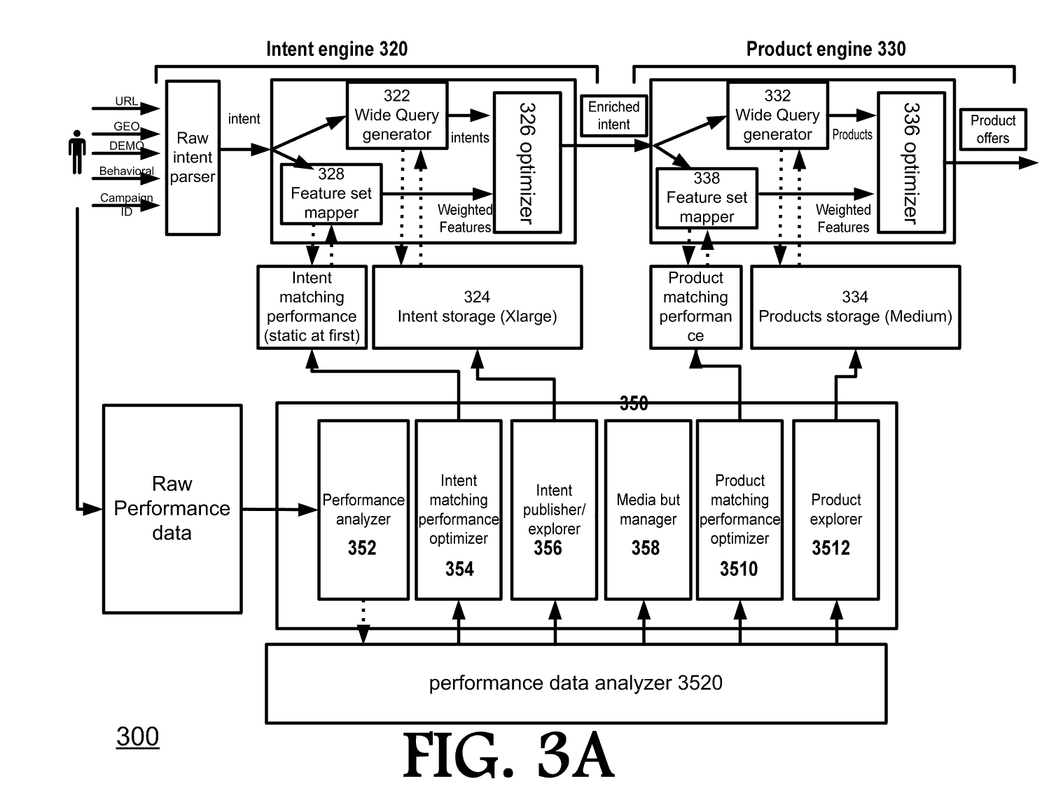

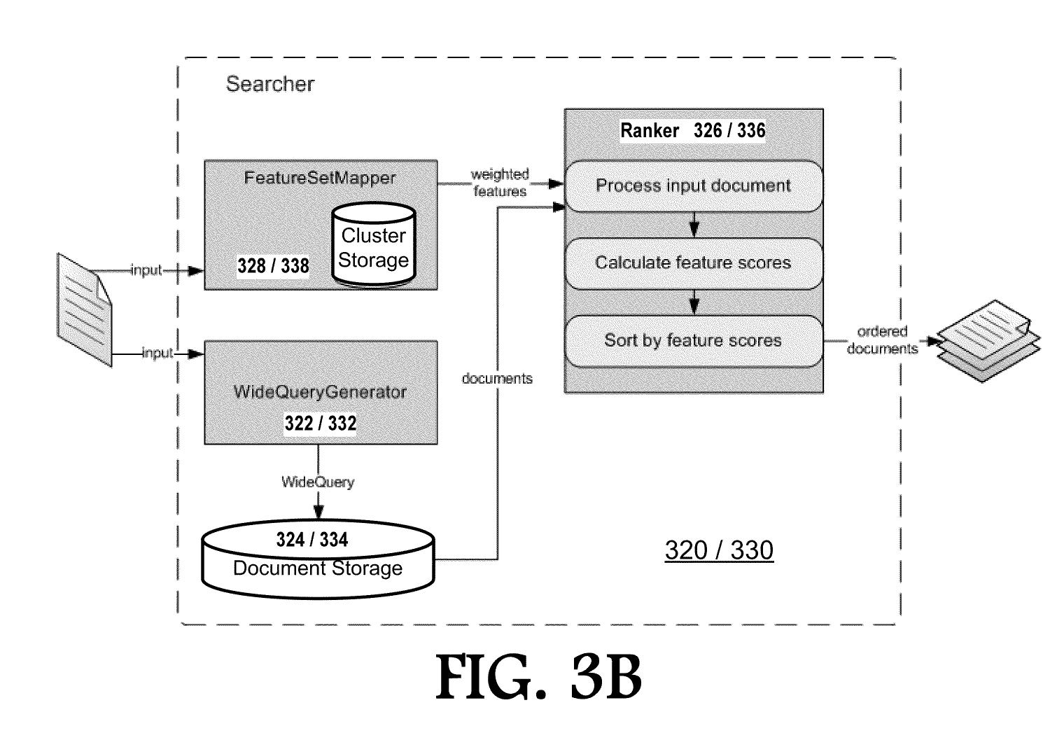

FIG. 3A illustrates architecture of a system 300 for generating an advertisement to be displayed to a website visitor of a webpage, according to an embodiment of the invention. It is noted that some embodiments of system 300 may implement different embodiments of method 500, but this is not necessarily so.

It is also noted that different components of system 200 may be interchangeable with components of system 300, and that in various embodiments of the invention, different systems include some components of system 200 and some of those of system 300. By way of example, product selection processing module 220 of system 200 may be replaced, according to an embodiment of the invention, with product selection processing module 320.

Conveniently, system 300 may include two searching (and/or matching) modules (or implement two distinct search and/or matching instances). A first such module may be used to match a URL (or an intended impression) with an intent (or intent identifying parameters), and a second such module may be used to match an intent with a product offer.

According to various embodiments of the invention, intent processing module 320 (denoted “intent engine 320”) may process intent indicative information to provide enriched intent indicative information, and product selection processing module 330 (denoted “product engine 330”) may process intent indicative information (possibly enriched intent indicative information) for selecting at least one product. It is noted that product selection processing module 330 may and may not process the intent indicative information for selecting the at least one advertising campaign. It is noted that, according to an embodiment of the invention, a third searching (and/or matching) module that may be located between intent processing module 320 and product selection processing module 330 may process intent indicative information for selecting the at least one advertising campaign, wherein the processing of processing module 330 may be responsive to the results of such a third processing module. It is noted that any of those two or three processing module may be implemented in a single processing module capable of various selecting functionalities.

Referring to any of those two or three processing modules, the matching instances of any of those modules may conveniently be implemented in a similar way: (a) a call is made to the processing (e.g. searching and/or matching) module, containing all relevant (and possibly also irrelevant) parameters; (b) a query generator of that processing module (e.g. 322, 332) receives the input, and generates a possibly wide and permissive query based on the input, wherein the query generation may or may not be a “smart” query generation.

A storage engine of the processing module (e.g. 324, 334) may than accept the generated query, and return in response a set of at least one document that match the query.

An optimizer of the processing module (e.g. 326, 336) may than receive the most relevant documents, and rank the results in response to alternating weighted features and performance (which may be provided, according to an embodiment of the invention, by a feature set mapping module such as, e.g. 328, 338). It is noted that according to an embodiment of the invention, at least some of the features used by the optimizer (or otherwise by the respective processing module) may be query independent, and in that case may be calculated offline. It is noted that according to an embodiment of the invention, at least some of the features used by the optimizer (or otherwise by the respective processing module) may be query dependent, which may conveniently be calculated online.

Therefore, according to an embodiment of the invention, at least one of the selection instances of system 300 (and/or selection optimization instances), may be achieved by updating the weights of each feature—or other campaign parameters or campaign policy parameters—according to performance of the product selected in previous instances.

According to an embodiment of the invention, a document which is used in such a selection mechanism may include some or all of the following fields
Metadata Object (Location=London)
Data Object (Hotel Name=“Marriot London”
Raw Data (XML)
Intent independent Feature 1 (0.5)
Intent independent Feature 2 (some other value)
. . .

Intent processing module 320 may be used for providing an intent document that improves a fitting to an intent of the user. It may typically receive a URL, a geographic info and a demographic info (and possibly behavioral info as well), and combines them, using its underlying storage, into a document that contains information on the intent of the user. In our system, the intent indicative information (before and/or after such processing) may contain several “objects” such as geo location, URL objects, page keywords, and/or a structured information (e.g. coming from a Dapp of the page). It is noted that the preprocessed intent indicative information may also be an ‘empty’ intent, according to an embodiment of the invention, e.g. in cases where we don't know anything about the URL. Note that the intent's components can be weighted internally based on the reliability of the source. For example, intent processing module 320 may regard information coming from a structured feed as more relevant than information which is retrieved from the URL, and so forth.

According to an embodiment of the invention, an enriched intent indicative information document may include one or more of the following:
Geo data (calculated on the fly)
Demo data (given by a 3rd party cookie or something)
URL components
HTML keywords
word bag from Yahoo Boss
objects bag from open calais
Structured data from a Dapp
Probable verticals and categories

As for product selection processing module 330, it is noted that searching a product document based on the intent indicative information alone may sometimes be insufficient. Therefore, according to an embodiment of the invention, more information is provided to product selection processing module 330, e.g. pertaining to the product templates themselves, their categories, performance, and best features.

It is noted that, according to an embodiment of the invention, the campaign ID is one of the systems parameter, and thus a search for a campaign template may be implemented, according to an embodiment of the invention, as a simple search in a hash map. A campaign template (or other form of campaign parameters and/or campaign policy parameters) may often be used to determine attributes of the campaign policy. Policies will be manifested in product and intent features (e.g. by 328, 338). The campaign parameters (e.g. the campaign template) may contain the set of features of a product and their weights, so that when the optimizer (e.g. 326, 336) processes the features, it may calculate them and determine the rank of the product.

According to an embodiment of the invention, a campaign template, which may include some or all of the campaign/campaign policy parameters, may contain the followings:
Meta information on the product set, such as schemes
Abundant Product categories, verticals
Configurable advertiser search policy (such as “use geolocation to get nearest city” etc)
product document features set and weights

It is noted that, since according to an embodiment of the invention more than a single advertising campaign may be supported by system 300, system 300 may search the best campaign based on the intent indicative information or the enriched intent indicative information. It is noted that this may also be subject to the above disclosed general search scheme, which will be optimized based on performance.

Product selection processing module 330 may be used, according to an embodiment of the invention, provide based a ranked set of products, based on intent indicative information (which may be formatted as an intent document) and possibly also on campaign parameters and/or campaign policy parameters (which may be formatted as an advertiser template). To do that, product selection processing module 330 may use the general scheme of search that was described above.

Product selection processing module 330 may take the intent indicative information and the advertiser template and generate in response a query to the product storage engine 334. The query itself may be, according to an embodiment of the invention, a result of some relatively fast processing (e.g. a fast gluing calculation), or, if a relatively small number of advertiser products are available, all of the products of the campaign may be returned. Once an initial products set is returned, the optimizer/ranker (e.g. 326, 336) has to determine ranks for the products of the initial set. According to an embodiment of the invention, the processing by the optimizer may include weighing pre-calculated query independent features with online calculated set of query dependent features, to form a rank for the product, sorts and returns.

It is noted that each one of the searching and/or matching modules (e.g. 320, 330) may include both storage components and search engine implementation used for indexing, e.g. of intent data, product data. The search module may include some or all of:
a. Storage engine (e.g. 324, 334) that provides access to all features of the underlying search engine. It is noted that according to an embodiment of the invention, the storage is implemented by embedded Solr search engine, in which All embedded Solr search engines operate as slaves to one master search engine that contains all the indexed data;
b. Query generator (e.g. 322, 324) that generates queries for the storage engine. The generated query may be fuzzy enough to allow loose matching of other indexed documents of the same type, all the while maintaining the ability to limit the query by use of filter (again derived from the input document);
c. Feature set mapping module (e.g. 328, 338) that provides a mapping between the searched document and the feature weights used by the optimizer. The features set mapping module may represent, according to an embodiment of the invention, a mapping of documents to a set of weights that can be used to decide the ordering of the results given from the search engine; and
d. And optimizer (also referred to as “ranker”) that ranks all the results given by the storage for a specific query, according to a unique set of weights

According to an embodiment of the invention, system 300 may include optimization parameters engine 350 (denoted “offline web glue 350) for determining optimization parameters (which may be, according to an embodiment of the invention, the campaign parameters and/or campaign policy parameters, and may be used for the determining of the campaign parameters and/or campaign policy parameters). The optimization parameters of optimization parameters engine 350 may pertain to the processing of any one of the above discussed processing module (e.g. 320, 330, and so forth).

According to an embodiment of the invention, system 300 may include an intent updating module (denoted “intent/publisher explorer 356”, and which may and may not be a part of optimization parameters engine 350) which may find new intent documents and/or refresh old intent documents.

According to an embodiment of the invention, system 300 may include a product updating module (denoted “product explorer 3512, and which may and may not be a part of optimization parameters engine 350) which may implement one or more of the following functionalities: finding new products; refreshing old product documents; cleaning expired product documents, and/or calculating intent independent features for an explored product.

It is noted that, according to an embodiment of the invention, optimization of parameters, e.g. by optimization parameters engine 350, may relay on the following collection of data:
a. When the website visitor clicks the advertisement (or otherwise seems to respond to it), a respective log entry is registered (e.g. by raw data collector 340)
b. A performance data analyzer 3520 process collected performance data (collected from the website visitor, from an advertiser website, and/or from other sources), and provides analyzed performance data to difference modules (e.g. modules 354, 356, 358, 3510, and/or 3512), among which are, according to an embodiment of the invention, at least one weight optimizer (e.g. intent matching performance optimizer 354, and/or product matching performance optimizer 3510) and media buy manager 358.
c. The at least one weight optimizer analyzes the performance data—possibly per campaign, but not necessarily so—for updating at least one campaign parameter if necessary. It is noted that feature weights may be defined per campaign, and may be pertain to more than a single campaign (or to no specific campaign at all).

Media buy manager processes the performance data for determining whether to acquire additional media (URLs or user categories) to run on.

FIG. 3B illustrates a searching and/or matching module (e.g. 320, 330), according to an embodiment of the invention, and data flow within the searching module.

An input document (that includes intent indicative information) is passed through query generator 322/332, to produce a wide query (also referred to as WideQuery). The wide query is used on the storage 324/334 to retrieve a list of documents. The input document is passed through the feature set mapping module 328/338 to retrieve a list of weighted features. The input document, list of products and the weighted features are used by the optimizer 326/336 in order to sort the search results. The optimizer 326/336 returns a list of documents ordered by rank.

It is noted that according to an embodiment of the invention three searching modules instances are implemented:
a. Intent processing module 320 that uses the initial Intent document parsed from the request data to find the appropriate classification of the intent and set of weights which match that classification. The optimizer than uses this weights to find the best suited Enriched Intent document (including enriched intent indicative information) to return. The Enriched Intent document uniquely identifies the Campaign by which the products will later on be ordered.
b. A cluster searcher (implemented in the feature set mapping module) uses an Intent document to find a classification which matches that document, this searcher comes into play inside the feature set mapping module, and is used for finding the classification of an Intent document within the world of intents. In other words what classification does this Intent belong to: travel, electronics . . . . And the cluster searcher is also used by the product selection processing module 330 in order to find the campaign that maps to the given Intent.
c. Product selection processing module 330 that uses the enriched intent document given from the intent processing module 320, and searched for a matching list of documents and a campaign for which the Intent document is most relevant. The products are filtered and ordered according to the calculation of the features and their weights as defined by the campaign. The result of product selection processing module 330 is a list of products which are selected for the current impression.

Media buying manager 350 may be used for buying different types of intents, according to different embodiments of the invention. It may go to agencies looking for ‘Travel’ media that has a certain demo/geo profile (or otherwise categorized media), and offer these agency similar media for lower price than the price which they are used to pay (e.g. 10$ instead of 12$). Then, system 300 may look for untagged or semi-tagged media—e.g. impressions that have the right demo/geo, but no category. Media manager 350 may buy this cheap—let's say for $0.5. That means, when a user views a page, system 300 might get to show its advertisement—but can not know what the category of the page is until this happens. According to an embodiment of the invention, system 300 may try to figure out the category when the website visitor views the page. Following the same example, if it is a travel page, we show the selected advertisement (e.g. selected by product selection processing module 330) and received. This way, roughly, there is a profit of $9.5 on the deal.

If the page is not in the requested category (in that example—travel) system 300 may than categorize this page it into a different category, and sell it back to the Exchange—for someone else looking to show their ad to that category.

Today, Ad networks provide media to advertisers by allowing them to buy a set of impressions based on a certain criteria. This makes the ad visible to only those users that might care about the advertiser offerings. System 300 (and method 500) enables changing this world in two ways. First, by providing better targeting—on a coarse contextual level (‘travel inventory’), down to fine-grained intent level (‘young males interested in traveling to San Francisco’). Second, by matching specific advertiser offers to the intent of the user, in an aided or automated manner. It should be noted that these two notions (targeting and personalization) are related but different.

It is noted that the targeting and personalization may be implemented in different degrees, in different embodiments of the invention. For example, three variations of implementing targeting and personalization are offered, to clarify possible variations (wherein it is clear that other modifications are also included in the scope of the invention):
a. Variation 1—
   1. Target by Demo/Geo/Contextual/Behavioral—from Networks in Exchange
   2. Personalize based on available intent
b. Variation 2—
   1. Target by Demo/Geo/Behavioral—from Networks in Exchange
   2. Target by Contextual—from Networks in Exchange, or Contextualized by us
   3. Sell back Contextual media that we can't use
   4. Personalize based on available intent
c. Variation 3—
   1. Target by Demo/Geo—from Networks in Exchange
   2. Target by Contextual—Contextualized by us
   3. Sell back Contextual media that we can't use
   4. Target by Behavioral—from Networks in Exchange, or interpreted by us
   5. Sell back Behavioral media that we can't use
   6. Personalize based on available intent

Referring to variation 1, for example, we don't need contextual keywords from a page as much as we want to understand the category the page belongs to—one of the pre-defined categories. So, a strategy that focuses on characterizing the type of *site* the URL belongs to quickly, makes sense.

Of course, it's possible that in order to understand the site, multiple URLs from the site need to be evaluated. So, per-URL context extraction would also be needed.

Site classification approaches which may be used, for example:
a. DMOZ and Yahoo! Directory—given a URL, find if it belongs to one of the sites listed in these directories. A mapping between top-level categories and exchange categories will need to be established.
b. Dapps already run—assign labels to certain categories, and based on the existence of 2 or more labels of a certain category, assign site to a given category.
c. Auto-dapping—Dapp multiple pages from a given site to derive common elements, then check values of the elements in various dictionaries

URL content extraction approaches which may be used, for example:
a. Y! BOSS for keywords—use BOSS to find keywords corresponding to a given URL. Look up keywords into standard dictionaries, to classify them into categories
b. Y! SearchMonkey—get structured data for a given page/site when available to them
c. Contextual media—learn from the labels applied to media that is passed in

It is noted that at least one processing module of system 300 may process at least a portion of the intent indicative information (may be enriched intent indicative information), to provide a categorization (and/or at least one keyword and/or at least one tag) for an impression that is associated with the intent indicative information. The selling of media may be defined as serving an impression (e.g. that is bought from a network/publisher) with an HTML tag. some good examples of HTML tags that can be sold/assigned are:
a. dynamic ad tags, containing dynamic content
b. right media tags, targeted to sell for a specific buyer
c. category specific (say music) RM tags, not targeted to a specific buyer
d. proprietary ad tags (say Vizi's)

System 300 may implement different decision rules (also referred to as media serving rules) for determining to automatically buy media from its various sources. Some implementations of media buying have been discussed above.

According to an embodiment of the invention, a combination of campaign, creatives, and scenarios may define the media which is bought and sold on the system.

A campaign is, according to an embodiment of the invention, the top level definition from which all scenarios inherit properties. It contains a set of definitions such as flight dates and budget, and a set of scenarios that may override the campaigns attributes or use them. Key features are, according to an embodiment of the invention:
a. Id (a.k.a adld)
b. Buyer
c. A List of scenarios
d. Type (e.g. Static or Dynamic)
e. General attributes that must be specified but may be overridden by the scenario:
   1. start date
   2. end date
   3. minimum margin
   4. overall budget and CPM/CPC/CPA goals

A scenario defines a overall budgeted bid over intent, to show one of the chosen creatives. Key features are, according to an embodiment of the invention:
a. A price
b. An intent targeting
c. A list of creatives
d. Optional attributes that may be inherited from the campaign:
   1. start date
   2. end date
   3. minimum margin
   4. maximum budget

A creative defines the type (and possibly quality) of the media sold, as well as the HTML tag to be displayed. Key features are, according to an embodiment of the invention:
a. Name
b. HTML tags (these may be generated dynamically, as they may be an ad containing dynamic contents)
c. Id

According to an embodiment of the invention, there is a need to select from within the matching Media Tags, which one to display, wherein the parameters used may be, for example:
a. client requirements
b. media/campaign performance
c. media/campaign prices
d. media availability
e. . . .

According to an embodiment of the invention, system 300 may be probabilistic in nature, and utilize statistic learning and some form of optimization to calculate the best probable choice. According to an embodiment of the invention, a two phase process may be implemented, in which:
a. Each Media Tag is assigned with a probability of “match” or “success”
b. Each Media Tag is assigned with a probability of being the optimal decision from clients perspective

For example, probabilities may be multiplied by some weights, and a probabilistic decision is made with some extent of exploration/exploitation.

According to an embodiment of the invention, system 300 may store flash cookies and/or hypertext transfer protocol (HTTP) cookies on the user's browser. Using http cookies is straight forward and doesn't require any complicated implementation, while using flash cookies may require slight complexity.

According to an embodiment of the invention, system 300 may utilize a servlet which may be used to save intent information of stubhub ad viewers. That servlet may, according to an embodiment of the invention, view an existing cookie, add the current impression's applyToUrl, and will return an XML. It may tell the flash to do the following:
a. For each <pixel> element, fetch the pixel. These may be RM pixels with which we'll want to buy impressions later.
b. Store the new flash cookie on your shared object.

As for Flash cookies, two cases which may be implemented for serving, depending on who is serving the ad, are:
a. The HTML tags are served by system 300 (no adld specified)
b. The HTML tags are served by third party (adld specified)

According to such an embodiment of the invention, the browser of the website visitor will load a container SWF file. Once a flash container is loaded into an html page, it will load an internal 1×1 SWF file which will look at the flash cookie and return the container with the stored flash cookie. The container then, can use the flash cookie to access a servlet with the cookie info that it was given, and a parameter format=swf, indicating that it expects a SWF file with the result XML embedded into the SWF, in return. It is noted that in the second case, according to an embodiment of the invention a container is not used, wherein said servlet may be accessed with simply format=xml and receive an XML result back.

According to an embodiment of the invention, http cookies are used (which may require simpler implementation) and it doesn't require the flash to store flash cookies or use a flash container. In this case, when a call is made to the servlet with either format=xml or format=code, the servlet will use the regular http cookie to figure out the intent.

According to an embodiment of the invention, retargeting pixel may be used, e.g. for retargeting a specific campaign. In this case, the client will place a pixel on his site, typically in a product page, and a cookie will be registered in the user browser, indicating that the user has visited the product page. Having this cookie may assist in making better contextualization in the future. Conveniently, information of a cookie may only be used for a single campaign.

Pertaining to both system 300 and method 500, different categorization methods may be used (for HTML webpages and/or for other types of webpages). For example, some categorization methods which may be used are:
a. Nearest page
b. NER (named entities recognition)
c. SVM categorization (statistical learning algorithm).

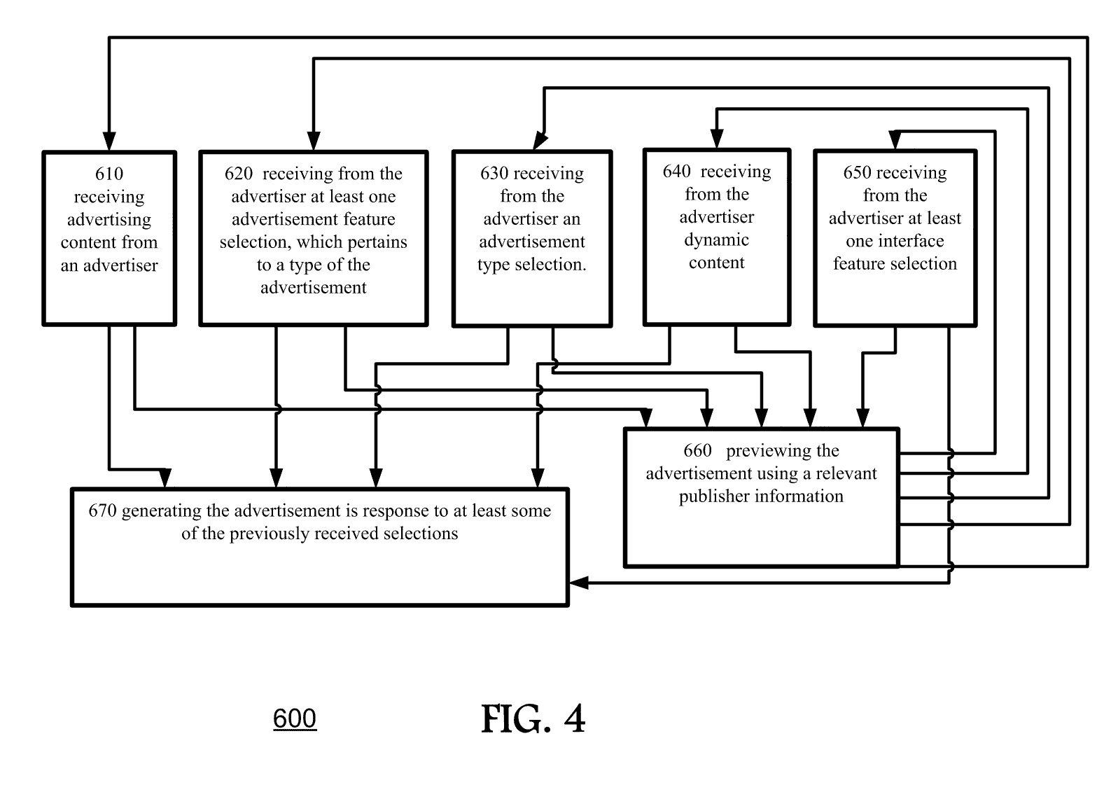

FIG. 4 illustrates method 600 for generating advertisement, according to an embodiment of the invention. Method 600 may start with stage 610 of receiving advertising content from an advertiser. According to an embodiment of the invention, the receiving of the advertisement content includes receiving a selection of an advertiser feed that is associated with the advertiser, wherein the advertiser feed refers to advertisement content stored in a database, which could be updated from time to time (by the advertiser, automatically, or otherwise). It is noted that conveniently the advertiser can only select advertisement feed that is associated with the advertiser, and can not review advertisement feeds of other advertisers.

Stage 620 of method 600, which may an may be not implemented, includes receiving from the advertiser at least one advertisement feature selection, which pertains to a type of the advertisement. In this step, the advertiser chooses what capabilities his ad will have, both from the advertiser perspective and from the publisher's perspective. According to an embodiment of the invention, the type of functionalities fall into three types:
a. Contextual—The ad will have the capacity to use publisher content as input. That means the ad will be filled with advertiser content that is contextual and mashup with the content of the page on which it is embedded. See “Serving a Mashup Ad” flow for implementation of this capability
b. Behavioral (Personalized)—The ad will have the capacity to use advertiser related information as input for matching advertiser info against. On this version, the only advertiser information supported will be GeoIP extraction. See “Serving a Behavioral Ad” flow for implementation details.
c. Interactive—The ad will consist of interactive advertiser inputs a segment like an inline search, dynamic filters etc.

The advertiser can also choose to use publisher information as part of the ad.

Stage 630 of method 600, which may and may be not implemented, includes receiving from the advertiser an advertisement type selection. Conveniently, the receiving of the advertisement type selection is preceded by providing to the advertiser multiple advertisement types to select from, wherein, according to an embodiment of the invention, the providing of the multiple advertisement types is responsive to the receive advertisement features selection.

As part of the system, there is a set of available functional ad templates for the advertiser to choose from. In this step, the advertiser is presented with a filtered set of ad templates that are related to his previous selections. According to an embodiment of the invention, the advertiser can provide different advertisement feature selections (e.g. if he is not satisfied with the provided advertisement types), wherein whenever the advertiser changes his advertisement features selection, the list of presented advertisement types (with is conveniently presented as templates) should conveniently immediately update. Conveniently, each advertisement type has associated examples image/iframe showcasing a set of compelling examples using the template.

Stage 640 of method 600, which may an may be not implemented, includes receiving from the advertiser dynamic content (or dynamic content selection)—which may include receiving from the advertiser real time information which may be used, for example, in stage 551 of method 500. In stage 640, the advertiser can choose which fields/groups will be part of his ad. The advertiser can also create action fields which are functionally derived from the raw content. The advertiser previews actual sample content extracted from sample publisher pages, and the respected advertiser content.

The receiving of the dynamic content may include receiving from the advertiser fields selection (e.g. defining Publisher/Advertiser participating fields): The advertiser can choose which publisher and advertiser content he wants to include in his ad. For fields that include a link, the advertiser can choose to disable the link or manually edit it (e.g. add a prefix, a suffix etc.). The advertiser can choose to build a general destination URL function for the ad based on all available content fields and URLs. In some templates, building a destination link is mandatory. An advertiser can choose to build action fields, which present some functional transformation of available content field.

The receiving of the dynamic content may include receiving from the advertiser action fields. Action fields are a functional transformation of available content, with emphasis on aggregate functions (min/avg/sum etc.), and string transformations (trim/upper-lower case/cut etc.). More complex transformation functions will also gradually be added (e.g. translate a field into another language, extract keywords, geocode etc.)

The receiving of the dynamic content may include providing to the advertiser sample input content coming from a sample relevant publisher. The advertiser is also presented with the output advertiser content matching the input content. The advertiser can choose other sample pages from other publishers, and even to add a publisher.

Stage 650 of method 600, which may and may be not implemented, includes receiving from the advertiser at least one interface feature selection. In this step, the advertiser can choose various presentation layer options such as size, grouping behavior, layout and supported platforms. This step is a composed of a hybrid html/flash application. The flash application is used as a layout canvas on which the advertiser can design his ad layout, and is reflecting both advertiser choices on the canvas as well as his design choices in the options outside the canvas. According to some embodiments of the invention, the following interface features are manageable: (a) ad dimensions: The advertiser can choose the ad size he wants to build, out of the various IAB standard ad sizes. Changing this property affects the size of the ad on the canvas; (b) group navigation advertiser interface: The advertiser can choose between different group navigation behavior and other template custom choices (such as table layout, paginated etc.). If needs be, additional contextual options will appear. For example, in the example below, the advertiser has chosen paginated, and thus is presented with several navigation options between the various entries; (c) interactive filters: Interactive filters are elements which add interactivity to the template. They are based on one of the existing content fields in the ad, which the advertiser chooses to add as a filter also. The advertiser then chooses for each filter how it will be presented: List, combo box, slider (when the field chosen is a number field) and more; (d) supported platforms: The advertiser can choose to add to his ad support to one or more of the supported platforms. The ad assembler will use these choices to add the relevant code to the ad; (e) canvas: The canvas area is where the advertiser defines what will be part of his ad and previews the functionality of the ad in context. He can drag any element across the canvas.

It is noted that conveniently, the receiving of the at least one interface feature selection includes re-rendering of the flash canvas following any change in the selections of the advertiser, to respect his new choices. The output of the canvas to the ad assembler is the final locations of the various visual elements used in the ad.

According to an embodiment of the invention, method 600 includes stage 660 of previewing the advertisement using relevant publisher information (this is usually an advertisement which will not be provided to a website visitor, but which is used by the advertiser to examine how advertisement will be received by website visitors). In this step, the advertiser can choose to preview the ad in one of the relevant publishers suggested, or add a new publisher and view the ad on his site. The proxy page is searched for ad units identical in size to the ad created. If a unit is found, it is replaced by the ad and is brought above the fold. If an identical unit is not found, the ad is overlaying the closest unit. The ad unit is hosted in a draggable iframe that can be moved around in the page. The site itself is completely browsable and the advertiser can browse to other pages in the site and see how the ad adapts to their content.

Stage 670 of method 600 includes generating the advertisement is response to at least some of the previously received selections of stages 610, 620, 630, 640, and/or 650. According to an embodiment of the invention, the generating is further responsive to additional information other than the selection that was received during the previous stages. It is noted that, according to an embodiment of the invention, the generating of stage 670 may be further responsive to intent indicative information that is indicative of an intent of a website visitor, to which the advertisement is provide (wherein method 600 may further include providing of the advertisement to the website visitor).

It is noted that the information gathered in any one of stages 610, 620, 630, 640, and/or 650 may be used for the generating of the advertisement in different embodiments of method 500, and that any one or more of these stages may be incorporated into method 500 in different embodiments of which. Also, it is noted that, according to an embodiment of the invention, different components of system 200 and/or of system 300 may implement the functionalities of stages 610, 620, 630, 640, and/or 650.

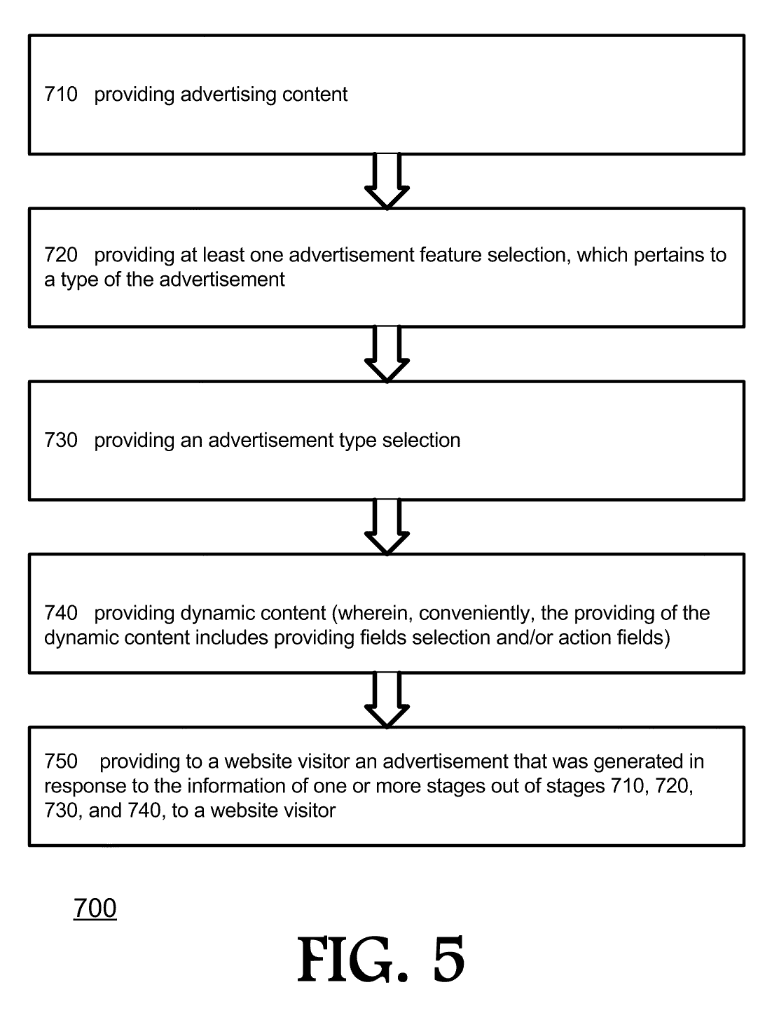

FIG. 5 illustrates method 700 for generating advertisement, according to an embodiment of the invention. It is noted that method 700 is conveniently carried out by the advertiser. The method 700 may include one or more of the following stages:
a. Stage 710 of providing advertising content. According to an embodiment of the invention, the providing of the advertisement content includes selecting an advertiser feed that is associated with the advertiser;
b. Stage 720 of providing at least one advertisement feature selection, which pertains to a type of the advertisement;
c. Stage 730 of providing an advertisement type selection;
d. Stage 740 of providing dynamic content (wherein, conveniently, the providing of the dynamic content includes providing fields selection and/or action fields).

It is noted that when at least all of the stages (a) through (d) are carried out, the advertiser have provided to a system for generating advertisement sufficient information to generate the advertisement as discussed above. Conveniently, method 700 conveniently includes providing at least one interface feature selection. It is clear to a person who is skilled in the art that different embodiments of the method 700 conveniently correspond to different the embodiments of the method 600.

Method 700 may further include stage 750 of providing to a website visitor an advertisement that was generated in response to the information of one or more stages out of stages 710, 720, 730, and 740, to a website visitor. According to an embodiment of the invention, the providing further includes providing to the website visitor the advertisement that was generated in response to the information of one or more stages out of stages 710, 720, 730, and 740 and to intent indicative information that is indicative of an intent of the website visitor.

It is noted that according to an embodiment of the invention, system 200 is capable of implementing method 600. According to an embodiment of the invention, advertisement generator 270 is configured to generate the advertisement using as code (which may be generated by an ad assembler of system 200 that is not illustrated, or by advertisement generator 270 that acts as such ad assembler). The ad assembler (AA) is conveniently configured to provide ad code in response to the selections and possibly further information provided by the advertiser, as discussed above.
a. 1. Generate Ad Code: every choice the advertiser has chosen is encoded and delivered to the AA, which assembles the ad code based on these choices. For example, the name of the Dapps used, as well as their variables are inserted into the code template. Optional components such as support for external platforms are included, as well as the locations of all elements on the canvas. The output of the AA is a fully functional flash code project. The AA is responsible to store the ad configuration, associate it with the advertiser account/campaign and save the code project on disk.
b. 2. Download Ad: The download ad step allows the advertiser to download the flash project created by the AA, and all that needs to deploy the ad.

According to an aspect of the invention, a computer readable medium having computer-readable code embodied therein for generating advertisements is disclosed, wherein different embodiments of the computer-readable code includes instructions for the carrying out of the different embodiments of the method 600.

It is noted that by creating semantic feeds (feeds that carry with them semantic information about their source), and creating mash-ups based ads on those feeds, relevancy can be enhanced by semantic targeting. If the page being viewed has semantic information associated with it, either by way of a semantic feed that has been created for that site, or by other mechanism (e.g. meta-tags) that information can be used to find advertisements that use feeds that are semantically similar and thereby creating a semantic targeting mechanism for advertisements to that site and advertiser.

It is further noted that several technical considerations are referred to, according to the invention, for generating Mash-up Ads and Landing Pages, among which are:
a. Data feed creation—since the “data feed” is the basic building block of a mash-up ad there needs to be a simple mechanism to create semantic data feed from any web source.
b. Caching—since the ad needs to bring data from various sources (including the advertiser current page) and create the ad on the fly—there needs to be a smart caching mechanism for the feeds data, components of the mash-up and the mash-up itself
c. Mash-up Services—A set of services that allow data feeds to be combined into the content feed of an ad.
d. Template based Integration—A method and tool to bring the content feed into a creative, rich media template on fly when an ad is served.
e. Advertisement and Landing Page Association—A method and tool for creating and associating the dynamic mash-up advertisement and its associated landing page. A mash-up landing page may be appropriate even for simple ads so that if a site has limitations on the type of ads that can be displayed, the landing page can still be tailored based on advertiser, site and 3rd party information
f. Metrics and Reporting—A reporting mechanism for the ad served, it effectiveness and efficiency and for the data feeds used as a part of the ad and landing page.
g. Standard Ad Creation—A method and tools that allows mash-up ads to be served through standard ad serving mechanism and providers (e.g. Microsoft Atlas, Doubleclick DART)

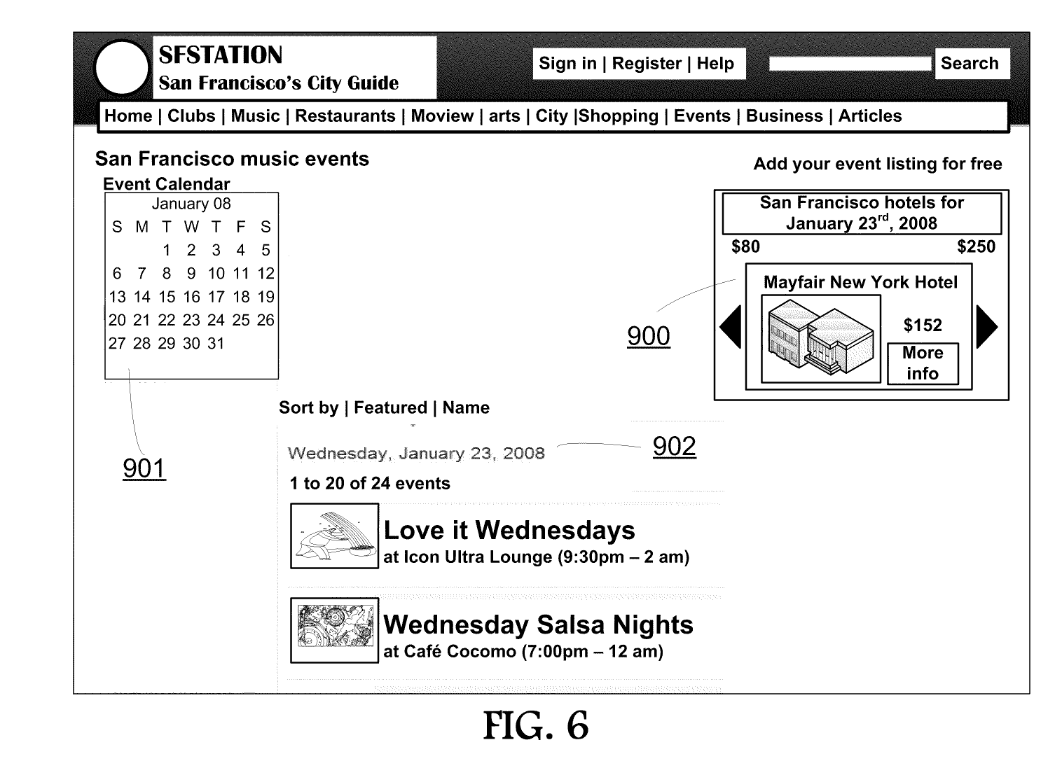

FIG. 6 illustrates an advertisement 900 generated in response to intent indicative information, according to an embodiment of the invention. For example, advertisement 900 may shows a live feed of hotels of a given hotels network, with the ability to browse hotel listings by the website visitor, and to narrow down by price. According to an embodiment of the invention, the generating of the advertisement is responsive to location and date fields (denoted 901, 902 respectively) found on the webpage (which is not related to hotels, in this case).

According to an embodiment of the invention, a first computer readable medium having a first computer readable code embodied therein for generating advertisement is disclosed, the first computer readable code includes instructions for: (a) selecting a product to be advertised; (b) retrieving real time information pertaining to the product; (c) generating the advertisement in response to the real time information; and (d) providing the advertisement for displaying on the webpage.

It is noted that the computer readable code may further include instructions for the implementing of other stages of methods 500 and/or 600. Especially:
a. According to an embodiment of the invention, the instructions included in the first computer readable code for generating may include instructions for generating the advertisement that comprises at least some of the real time information.
b. According to an embodiment of the invention, the instructions included in the first computer readable code for retrieving of the real time information may include instructions for retrieving the information from a promoted feed that is received from an external system over an internet connection.
c. According to an embodiment of the invention, the instructions included in the first computer readable code for retrieving of the real time information may include instructions for retrieving the information from a promoted feed that is received from an external system over an internet connection, and which inlcudes: (a) at least one selected element out of multiple elements of a web content representation; and (b) at least one equivalent element that is similar to the selected elements, and which is selected by the external system in response to a selection of the at least one selected element.
d. According to an embodiment of the invention, the first computer readable code may further include instructions for updating the advertisement, after the providing of the advertisement, in response to additional real time information that is different from the real time information.

According to an embodiment of the invention, a second computer readable medium having a second computer readable code embodied therein for generating advertisement is disclosed, the second computer readable code includes instructions for:

(a) receiving intent indicative information, indicative of an intent of the website visitor; (b) updating a value of a campaign parameter of a campaign of an advertiser, in response to information received from the advertiser; (c) selecting a product in response to the intent indicative information, wherein the selecting is responsive to the value of the campaign parameter; and (d) providing an advertisement of the product for displaying on the webpage.

It is noted that the computer readable code may further include instructions for the implementing of other stages of methods 500 and/or 600. Especially:
a. According to an embodiment of the invention, the second computer readable code may further include instructions for processing the intent indicative information in response to the campaign parameter, to provide enriched intent indicative information that is different from the intent indicative information; wherein the instructions included in the second computer readable code for selecting may further include instructions for selecting the product in response to the enriched intent indicative information.
b. According to an embodiment of the invention, the second computer readable code may further include instructions for receiving from the advertiser the information as a promoted feed that is received from an external system over an internet connection.
c. According to an embodiment of the invention, the second computer readable code may further include instructions for retrieving real time information pertaining to the product, and generating the advertisement in response to the real time information.
d. According to an embodiment of the invention, the second computer readable code may further include instructions for selecting an advertising campaign in response to the intent indicative information, before the selecting of the product; wherein the instructions included in the second computer readable code for selecting may further include instructions for selecting the product which is a product of the advertising campaign.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for generating an advertisement to be displayed to a website visitor of a webpage, the method comprising:
selecting a product to be advertised;
retrieving real time information pertaining to the product;
generating the advertisement in response to the real time information; and
providing the advertisement for displaying on the webpage.

2. The method according to claim 1, wherein the generating comprises generating the advertisement that comprises at least some of the real time information.

3. The method according to claim 1, wherein the retrieving of the real time information comprises retrieving the information from a promoted feed that is received from an external system over an internet connection.

4. The method according to claim 1, wherein the retrieving of the real time information comprises retrieving the information from a promoted feed that is received from an external system over an internet connection, and which comprises: (a) at least one selected element out of multiple elements of a web content representation; and (b) at least one equivalent element that is similar to the selected elements, and which is selected by the external system in response to a selection of the at least one selected element.

5. The method according to claim 1, further comprising updating the advertisement, after the providing of the advertisement, in response to additional real time information that is different from the real time information.

6. A method for generating an advertisement to be displayed to a website visitor of a webpage, the method comprising:
receiving intent indicative information, indicative of an intent of the website visitor;
updating a value of a campaign parameter of a campaign of an advertiser, in response to information received from the advertiser;
selecting a product in response to the intent indicative information, wherein the selecting is responsive to the value of the campaign parameter; and
providing an advertisement of the product for displaying on the webpage.

7. The method according to claim 6, further comprising processing the intent indicative information in response to the campaign parameter, to provide enriched intent indicative information that is different from the intent indicative information; wherein the selecting comprises selecting the product in response to the enriched intent indicative information.

8. The method according to claim 6, further comprising receiving from the advertiser the information as a promoted feed that is received from an external system over an internet connection.

9. The method according to claim 6, further comprising retrieving real time information pertaining to the product, and generating the advertisement in response to the real time information.

10. The method according to claim 6, further comprising selecting an advertising campaign in response to the intent indicative information, before the selecting of the product; wherein the selecting of the product comprises selecting the product which is a product of the advertising campaign.

11. A system for generating an advertisement to be displayed to a website visitor of a webpage, the system comprising: product selection processing module, configured to select a product to be advertised; an input interface for receiving real time information pertaining to the product; and an advertisement generator, configured to generate the advertisement in response to the real time information and to provide the advertisement for displaying on the webpage.

12. The system according to claim 11, wherein advertisement generator is configured to generate the advertisement that comprises at least some of the real time information.

13. The system according to claim 11, wherein the input interface is for receiving a promoted feed that comprises at least a portion of the information, and that is received from an external system over an internet connection.

14. The system according to claim 11, wherein the input interface is for receiving a promoted feed that is received from an external system over an internet connection, and which comprises the information, wherein the promoted feed comprises: (a) at least one selected element out of multiple elements of a web content representation; and (b) at least one equivalent element that is similar to the selected elements, and which is selected by the external system in response to a selection of the at least one selected element.

15. The system according to claim 11, further configured to update the advertisement, after the providing of the advertisement, in response to additional real time information that is different from the real time information.

16. A system for generating an advertisement to be displayed to a website visitor of a webpage, the system comprising:
a campaign parameters manager, configured to update a value of a campaign parameter of a campaign of an advertiser, in response to information received from the advertiser;
a product selection processing module, configured to select a product in response to intent indicative information that is indicative of an intent of the website visitor, and to the value of the campaign parameter; and
an output interface for providing an advertisement of the product for displaying on the webpage.

17. The system according to claim 16, further comprising an intent processing module configured to process the intent indicative information in response to the campaign parameter, to provide enriched intent indicative information that is different from the intent indicative information; wherein the product selection processing module is configured to select the product in response to the enriched intent indicative information.

18. The system according to claim 16, further comprising an input interface for receiving from the advertiser the information as a promoted feed that is received from an external system over an internet connection.

19. The system according to claim 16, further comprising an advertiser generator that is configured to generate the advertisement in response to real time information pertaining to the product.

20. The system according to claim 16, further comprising a campaign selection processing module configured to select an advertising campaign in response to the intent indicative information, before the selecting of the product; wherein the product selection processing module is configured to select the product which is a product of the advertising campaign.
